(19) United States
(12) Patent Application Publication
(10) Pub. No.: US 2003/0132352 A1
(43) Pub. Date: Jul. 17, 2003

(54) Disposable hospital bed tube organizer

(76) Inventor: Dewitt Weaver, (US)

Correspondence Address: JOHN M. BRANDT, 60 THAXTER STREET, HINGHAM, MA, 02043, US

(21) Appl. No.: 10/050,809

(22) Filed: Jan. 14, 2002

(51) Int. Cl. F16L 3/22

(52) U.S. Cl. 248/68.1; 248/205.3

(57) ABSTRACT

A disposable hospital bed tube, hose, and wire organizer consisting of a strip of a semi-flexible material attachable to the side rail of the bed and having a plurality of slots transversely disposed along the top of the strip to receive and secure the various tubes, hoses, and wires extending from a patient to medical devices involved in the care of the patient.

### BACKGROUND OF THE INVENTION

1. Field of the Invention

The invention resides in the field of medical appliances and more specifically relates to devices used in the care of a patient confined to a hospital bed.

2. Description of the Prior Art

Tube, hose, and wire organizers are known in the prior art, particularly for use in industrial and automotive applications. In these, a plurality of wires, hoses, tubes, and the like are routed from one location to another. These devices are usually permanently installed and are molded or formed to the diameter of the cylindrical device they are meant to restrain or position. Examples are sparkplug wire guides in automobiles and tube or hose holders in complex industrial process and manufacturing equipment. All of the devices of the above type known to the inventor are designed to secure a specific hose, tube, or wire in a permanent manner such that these components or parts will not move about during the operation or transportation of the particular equipment with which they are associated.

In contrast, the present invention is designed to receive and snugly hold and secure a variety of medical items of the aforementioned types in a manner which will not interfere with their operation and at the same time will allow rapid placement and rearrangement of their positions

### SUMMARY OF THE INVENTION

The invention may be summarized as a hospital bed disposable patient care tube, hose, and wire organizer comprising a strip of foam rubber or plastic foam having a plurality of slots disposed transverse the strip to a depth sufficient to hold the items in use. The strip while flexible and resilient has enough density to maintain it's shape and yet yield sufficiently to allow the insertion of medical patient care tubular units of varying diameter in the slots provided. Means for securing the slotted foam strip to a hospital bed are included and may consist of, for example, a band of adhesive tape running the length of the foam strip or, alternatively, straps arranged to wrap around the strip and the bed rail.

The invention is intended to be completely disposable, as is normally required for this type of medical short time use equipment, and is arranged to accommodate the range of sizes of tubes, hoses and wires normally encountered in a hospital environment.

The features and advantages of the invention will be more fully understood from the drawings and description of the preferred embodiment which follows.

### DESCRIPTION OF THE DRAWINGS

FIG. 1 is a perspective view of the preferred embodiment of the invention;

FIG. 2 is a front view of the embodiment of FIG. 1;

FIG. 3 is plan view of the embodiment of FIG. 1;

FIG. 4 is a front view of an alternative embodiment of the invention; and

FIG. 5 is a side view of the embodiment of FIG. 4.

### DESCRIPTION OF THE PREFERRED EMBODIMENT

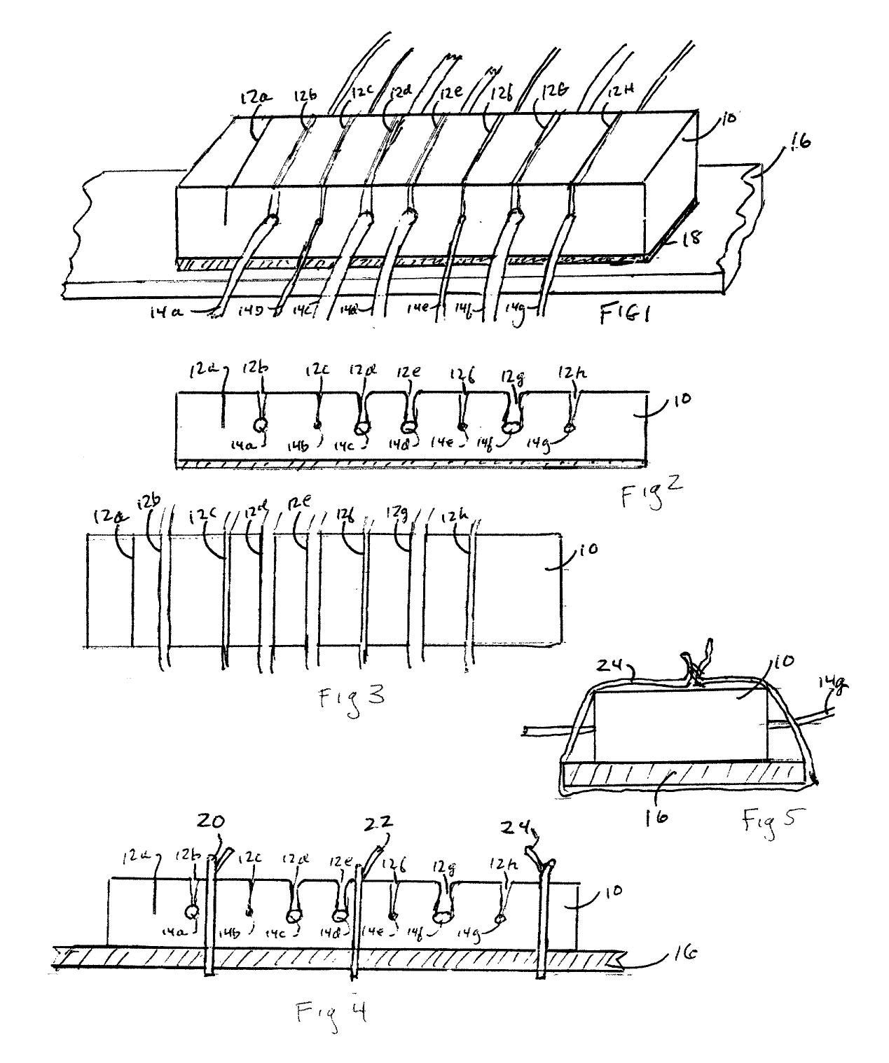

Referring first to FIG. 1, there is illustrated a perspective view of the preferred embodiment of the invention comprising organizer block 10 having a plurality of thin slots 12a-12h disposed across the width of the block. The block is composed of a sterilizable flexible resilient material such as plastic foam or foam rubber which will part to receive a variety of medical hoses, tubes, and wires 14a-14b but which has sufficient stiffness to secure each of these items to prevent them from becoming entangled with one another. Slot 12a is in the example, left unoccupied.

Organizer block 10 is shown secured to bed rail 16 by, for example, a sheet of adhesive 18 which may comprise doubly backed peelable adhesive Upon completion of use, the unit is disposed of by tearing away the block and adhesive from the rail.

Referring next to FIGS. 2 and 3, front and top views of the embodiment of FIG. 1 are shown for purposes of clarification.

FIGS. 4 and 5 illustrate an alternative method of securing disposable organizer 10 to bed rail 18. In this embodiment, tie downs 20, 22, and 24 wrap around the block and rail to hold the block in place. They may then be removed by cutting to allow disposal of the block.

As variations in the structure of the above disclosure will now be obvious to those skilled in the art, the invention is accordingly defined by the following claims.

What is claimed is:

1. A disposable medical tube, hose, and wire organizer attachable to a hospital bed rail comprising in combination:
a. An organizer block comprised of a flexible resilient material having a plurality of slots for receiving said medical tubes, hoses and wires, said slots disposed transverse the face of said block; and
b. Means for attaching said block to said rail.

2. The apparatus of claim 1 wherein said attachment means comprises an adhesive overlayed on the face of said block opposite said slots.

3. The apparatus of claim 1 wherein said attachment means comprises at least two tie downs arranged to encompass said block and said rail.

4. The apparatus of claim 1 wherein said material comprises sterilizable foam rubber.

5. The apparatus of claim1 wherein said material comprises sterilizable plastic foam
